(19) United States
(12) Patent Application Publication
(10) Pub. No.: US 2026/0280872 A1
(43) Pub. Date: Sep. 17, 2026

(54) Dynamix Data Encryption Key Management

(71) Applicant: Capital One Services, LLC, McLean, VA (US)

(72) Inventor: Laxminarayan Mani, Glen Allen, VA (US)

(21) Appl. No.: 19/079,765

(22) Filed: Mar. 14, 2025

(51) Int. Cl. H04L 9/08

(52) U.S. Cl. CPC H04L 9/0891; H04L 9/0822; H04L 9/0897

(57) ABSTRACT

Methods, systems, and apparatuses are described herein for dynamically implementing changes to encryption keys used to secure data. A computing device may store data encrypted using a first data encryption key generated using a first key encryption key. Based on receiving an indication of an expiration of the first key encryption key, the computing device may use a second key encryption key to generate a second data encryption key. The computing device may then decrypt encrypted data that was encoded using the first data encryption key and re-encrypt the data using the second data encryption key. Associations between data and keys may be used to identify which data to decrypt and re-encrypt, and not all data need be decrypted and re-encrypted at once.

### FIELD OF USE

Aspects of the disclosure relate generally relate to data encryption. More specifically, aspects of the disclosure may provide for dynamically implementing changes to encryption keys used to secure data.

### BACKGROUND

Computing devices managing sensitive data (e.g., personally identifiable information, medical information, financial information) often store that data in an encrypted format. That data may be encrypted using a data encryption key. In this way, the stored data is protected because it is encrypted, and the key(s) required to encrypt/decrypt the data are also protected by virtue of being stored in a uniquely secure portion of hardware. In some instances, a data encryption key may be generated using an algorithm or process, such as through use of a different key, sometimes referred to as a key encryption key.

The process of encrypting and managing sensitive data can be computationally time-consuming and difficult. For example, in particularly fast-moving computing environments, it can be difficult to quickly encrypt and decrypt data as necessary. Moreover, some schemes implement periodic rollover of data encryption keys and/or key encryption keys, but this can introduce significant delays in data availability because such rollovers might require the complete decryption and re-encryption of all data. Worse yet, if a key (whether a data encryption key or a key encryption key) is compromised, this can introduce significant vulnerabilities, and implementation of new key(s) can introduce similar delays as in the case of a key roll-over.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein relate to managing encryption keys (e.g., data encryption keys, key encryption keys) in a manner which can permit computing devices to dynamically implement new keys in a cutover process which does not significantly impact system uptime and which can help preserve security. As will be described in further detail below, this process involves associating data with the specific versions of data encryption keys and/or key encryption keys: for example, newly-encrypted data might be associated with metadata indicating a particular version number of a data encryption key and/or key encryption key involved in its encryption. Some time later, it may be then desirable to implement a new data encryption key and/or key encryption key: for example, either or both keys may be periodically rolled over (e.g., every year, every three years), and/or one or more of the keys may have been compromised in some manner. The implementation of any new keys may involve a three-stage process. Initially, before any new keys are implemented, data might be encrypted using any number of different older versions of data encryption keys (which themselves might be generated based on older key encryption keys). Then, an intermediary process, different subsets of the data might be decrypted and re-encrypted using new key(s). The old data encrypted using the older versions of the data encryption keys might be preserved in this intermediary process, as doing so might ensure uptime in some circumstances. Eventually, the computing device might ensure that all data is encrypted using the new data encryption key(s) (which themselves might be based on new key encryption key(s)). At his stage, any older versions of the data (e.g., data encrypted using old/expired keys) may be deleted; however, in some circumstances, the older data might be preserved for a period of time in case a rollback is necessary. The result of this process is a procedurally gentle, iterative process whereby keys can be rotated periodically and/or based on security concerns without impacting uptime and in a safe manner.

More particularly, a computing device may receive data to be securely stored in a database. The computing device may then retrieve (e.g., from some portion of the computing device or from an external source, such as from a Hardware Security Module (HSM) communicatively connected to the computing device over a network) a first data encryption key that was previously generated using a first key encryption key and encrypt the data using the first data encryption key. The computing device may store, in the database, an association between the encrypted data and version information corresponding to the first data encryption key. For instance, that association may be stored in a header of the encrypted data. Based on receiving an indication of an expiration of the first key encryption key (e.g., an indication that the first encryption key is compromised and/or a determination that a duration of use of the first key encryption key satisfies a threshold), the computing device may then receive a second key encryption key, generate, using the second key encryption key, a second data encryption key, and decrypt the encrypted data using the first data encryption key based on a determination that the encrypted data was encrypted using the first data encryption key. That determination that the encrypted data was encrypted using the first data encryption key may be based on the association between the encrypted data and the version information. The computing device may then encrypt the data using the second data encryption key and store, in the database, an association between the encrypted data and second version information corresponding to the second data encryption key.

The process detailed above may be repeated with different data as desired. Indeed, one of the many advantages of the present disclosure is that all data need not be decrypted and re-encrypted at once, preserving uptime and avoiding excess computational effort all at once. For example, the computing device may, based on the receiving the indication of the expiration of the first key encryption key, identify second data encrypted using the first data encryption key and, in response to identifying, using a second association between second encrypted data and third version information, that the second encrypted data was encrypted using the first data encryption key, decrypt the second encrypted data using the first data encryption key to generate second data. The computing device may then encrypt the second data using the second data encryption key and store, in the database, an association between the second encrypted data and fourth version information corresponding to the second data encryption key.

Another of the many advantages of the present disclosure is that it may be performed in conjunction with servicing requests for data, meaning that data re-encryption using a new key may be performed when the data is already decrypted to provide to a user. For example, the computing device may receive, from a second computing device, a request for second encrypted data and may, in response to identifying, using a second association between the second encrypted data and third version information, that the second encrypted data was encrypted using the first data encryption key, and after receiving the indication of the expiration of the first key encryption key, decrypt, using the first data encryption key, the second encrypted data to generate second data. The computing device may then send the second data to the second computing device, encrypt the second data using the second data encryption key, and store, in the database, an association between the second encrypted data and fourth version information corresponding to the second data encryption key.

As suggested above, all or portions of the keys (e.g., data encryption keys, key encryption keys) may be stored in a hardware security module, such as an HSM located on a network, as part of a computing device, or the like. For example, the computing device may store both the first data encryption key and the second data encryption key in the HSM. This may ensure that the keys are kept secure on the computing device.

Corresponding methods, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts a system comprising a data server and a user device.

FIG. 3 depicts a flow chart comprising steps which may be performed to implement changes to encryption keys used to secure data.

FIG. 4 depicts key encryption keys and data encryption keys.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects described herein relate to managing key encryption keys and data encryption keys for data encryption in a manner which can provide an iterative, uptime-focused, and ultimately secure approach to key roll-over. This process may allow new keys to be implemented such that data, previously encrypted with an older version of a data encryption key (e.g., based on an older version of a key encryption key), can be decrypted and re-encrypted using a new data encryption key. For example, as requests for data are received, when that data is decrypted (e.g., using an old data encryption key) for delivery, then the data might then be re-encrypted using a new data encryption key and stored. As another example, in the event that a key encryption key becomes compromised, a new key encryption key may be used to generate a new data encryption key, then all or subsets of data may be decrypted using an old (potentially compromised) data encryption key and re-encrypted using the new data encryption key. This process may advantageously protect the uptime of a system: for example, old data encrypted using an old and/or expired key need not be deleted immediately, but might be stored for a period of time to preserve uptime.

As an example of how the present disclosure may operate, a computing device may receive data to store, and may then use a first data encryption key (generated using an original key encryption key) to encrypt and store that data. The computing device may store an association between the encrypted data and a version of the first data encryption key and/or original key encryption key as well, in effect recording what key(s) were used to encrypt the data. Later, based on receiving some indication that the original key encryption key should be replaced (e.g., an indication that the key has expired, become compromised, or the like), the computing device may receive a new key encryption key and generate a new data encryption key using the new key encryption key. The computing device may then decide whether to decrypt data using the old data encryption key and re-encrypt that data using the new data encryption key. Such a decision might be made in response to a request for particular data (e.g., leveraging the fact that the response to the request already involves decrypting the data), might be made based on a popularity and/or sensitivity of portion(s) of data (e.g., immediately decrypting and re-encrypting high-priority data and bothering with other data later), or the like.

Aspects described herein improve the functioning of computers by improving the manner in which computers encrypt and store data and manage the process of such encryption. Data encryption is a computer-implemented function that has various flaws, including the vulnerability of data encryption keys stored on computing devices. Aspects described herein make the process of implementing new key encryption keys and/or data encryption keys more efficient, preserving system uptime (e.g., data availability) while also efficiently ensuring that data is securely stored. There is not a human equivalent for such a process.

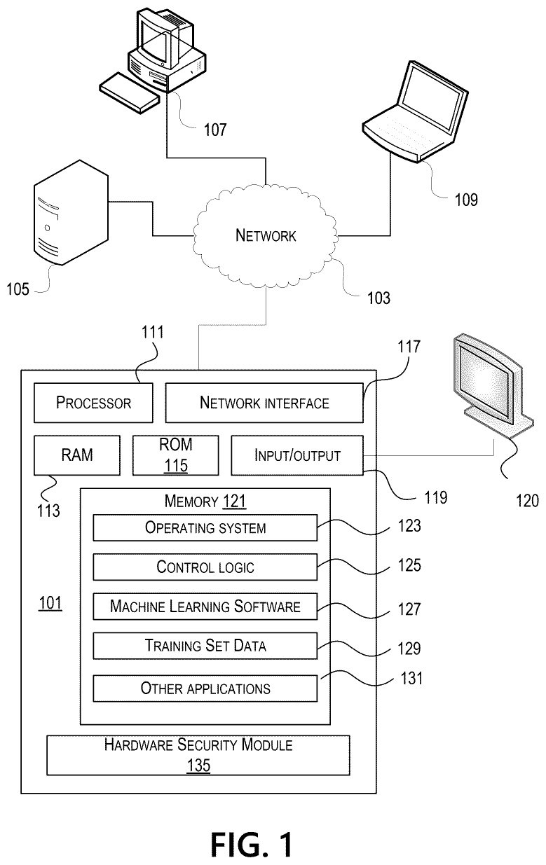

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Devices, such as devices 101, 105, 107, and/or 109, may additionally or alternatively comprise a hardware security module 135. For simplicity of explanation for the purposes of FIG. 1, the hardware security module 135 is shown as part of a device; however, the hardware security module 135 may be external to the devices (and, e.g., some module on a network). The hardware security module 135 may be configured to store one or more encryption algorithms, one or more keys (e.g., key encryption keys, data encryption keys), one or more passwords, or the like. The hardware security module 135 may be wholly or partially separated from other aspects of a computing device. For example, the hardware security module 135 may be accessible only in accordance with specific Application Programming Interfaces (APIs), via only specific programs, or the like. In this manner, the hardware security module 135 may be configured to securely manage processes such as encryption and decryption.

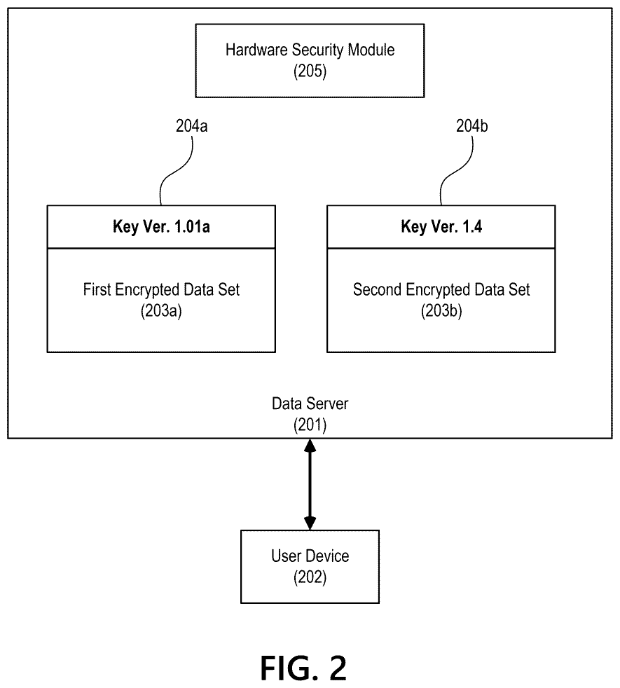

FIG. 2 depicts a system comprising a data server 201 and a user device 202. The data server 201 and the user device 202 are shown as communicatively connected, such as via the network 103. The devices depicted in FIG. 2, including the data server 201 and the user device 202, may be a computing device, such as any of the devices described with respect to FIG. 1.

The data server 201 may comprise one or more computing devices (e.g., a single server, multiple servers in a network) that may be configured to receive data, encrypt that data, store that encrypted data, receive requests for data, decrypt data, and/or transmit that decrypted data in response to those requests. For example, the data server 201 is shown storing a first encrypted data set 203a and a second encrypted data set 203b. FIG. 2 illustrates that these encrypted data sets might have been encrypted based on different versions of a data encryption key: for instance, the first encrypted data set 203a is shown in box 204a as having been encrypted using a key with version 1.01a, whereas the second encrypted data set 203b is shown in box 204b as having been encrypted using a key with version 1.4. Associations between data and the key(s) used to encrypt that data might be stored in the header of the encrypted data itself, as metadata, in a separate database, and/or the like. For instance, the data server 201 may store a tabular database that indicates, for each of a plurality of different data sets, which data encryption key(s) and/or key encryption key(s) are associated with the encrypted data. This may advantageously allow the data server 201 to quickly identify which key(s) should be used to decrypt the data, as well as what encrypted data might be encrypted using an expired version of a data encryption key (e.g., a data encryption key based on an expired key encryption key, a comprised data encryption key, or the like).

The data server 201 may additionally comprise a hardware security module 205 or similar element configured to manage encryption keys, such as key encryption keys and/or data encryption keys. The hardware security module 205 may be the same or similar as the hardware security module 135 of FIG. 1. For example, the hardware security module 205 may store one or more key encryption keys and/or one or more data encryption keys. As another example, the hardware security module 205 may be configured to generate one or more new data encryption keys based on one or more key encryption keys. As another example, the hardware security module 205 may be configured to encrypt data using one or more data encryption keys and/or decrypt encrypted data using one or more data encryption keys.

The user device 202 may be configured to send data to the data server 201, request data from the data server 201, and/or receive data from the data server 201. For example, the user device 202 may transmit data to the data server 201 for that data to be encrypted and stored. As another example, the user device 202 may request data from the data server 201 and may receive, from the data server 201, a decrypted form of the requested data. While referred to as a user device in FIG. 2, the user device 202 need not be operated by a user: it may comprise another server (e.g., as part of a website provided on the Internet) or the like.

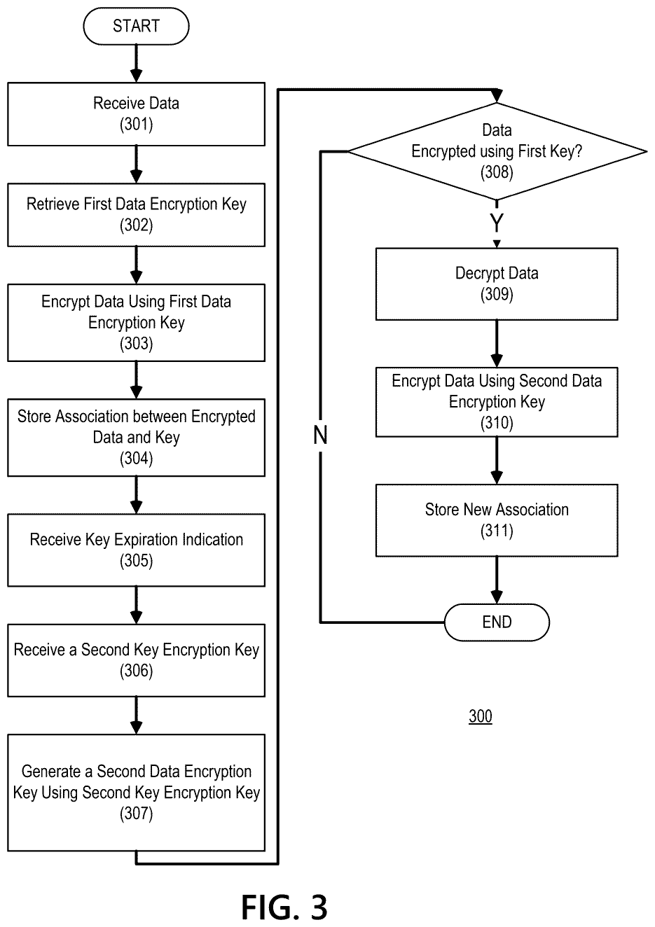

FIG. 3 depicts a flow chart depicting a method 300 comprising steps which may be performed by a computing device, such as the data server 201, for implementing changes to encryption keys used to secure data. A computing device may comprise one or more processors and memory storing instructions that, when executed by the one or more processors, cause performance of one or more of the steps of FIG. 3. One or more non-transitory computer-readable media may store instructions that, when executed by one or more processors of a computing device, cause the computing device to perform one or more of the steps of FIG. 3. Additionally and/or alternatively, one or more of the devices depicted in FIG. 2, such as the data server 201, may be configured to perform one or more of the steps of FIG. 5. For simplicity, the steps below will be described as being performed by a single computing device; however, this is merely for simplicity, and any of the below-referenced steps may be performed by a wide variety of computing devices, including multiple computing devices.

In step 301, a computing device may receive data. For example, the computing device may receive data to be securely stored in a database. The data may comprise sensitive data, such as healthcare information, financial information, personally identifiable information, or the like. Accordingly, the computing device may receive, albeit temporarily, unencrypted data that might ultimately be encrypted and stored for security reasons.

In step 302, the computing device may retrieve a first data encryption key. Data encryption keys may be received externally (e.g., from one or more servers, from an external HSM) and/or internally (e.g., from an internal HSM). For example, the computing device may retrieve, from a hardware security module (e.g., internal to or external to the computing device), a first data encryption key that was previously generated using a first key encryption key. The data encryption key may be a latest encryption key, such as the latest version of a data encryption key (e.g., a data encryption key generated using the latest version of a key encryption key). Different data encryption keys may be used for different types and/or portions of data, and retrieval of the first data encryption key may comprise identifying a data encryption key based on the data itself. For example, there may be one data encryption key for last names, another data encryption key for home addresses, and so on.

In step 303, the computing device may encrypt data using the retrieved data encryption key. For example, the computing device may encrypt the data using the first data encryption key retrieved in step 302. The encryption process for data may use one or more algorithms, and the key may be usable by the one or more algorithms such that decryption of the data may be difficult or outright impossible without the correct data encryption key.

While a single data encryption key is described throughout the present disclosure for the purposes of simplicity, the present disclosure may operate in the context of a public/private key pair, where encryption is performed using one key (e.g., a public data encryption key), and decryption is performed using a different key (e.g., a private data encryption key). Such a schema might be used for circumstances where a party wishes to send data confidentially to a party. In such a circumstance, the private data encryption key might be stored internally (e.g., on a hardware security module), but the public data encryption key might be available elsewhere (e.g., shared between different devices). While making a key public might allow acquirers of the key to decrypt the data, such an approach might be advisable in circumstances where, for example, the data is ultimately to be decrypted by the provider of a data request (rather than the computing device itself).

In step 304, the computing device may store an association between the encrypted data and the first data encryption key. This process may create a record of which data encryption key(s) were used to encrypt data, and that record might be usable to identify which key(s) are necessary to decrypt that data. The data encryption key might be identified in such an association using a unique identifier (e.g., a unique string), a version number, a data type identifier (e.g. one key for addresses, another key for e-mail addresses), or the like. For example, the computing device may store, in the database, an association between the encrypted data and version information corresponding to the first data encryption key.

Associations between keys and encrypted data may be stored in a variety of locations. For example, associations may be stored in the header of the encrypted data, in a separate database, and/or the like. Storing the key information in the header may be useful in a variety of situations: for example, in a public/private key pair setting, the information may be packaged with the data such that a device receiving encrypted data can identify, in its own data store (e.g., in its own hardware security monitor), a corresponding public key for decryption. As another example, storing the key information in the header may ensure that, in a cloud storage situation where data is stored in a redundant manner, the associations are not disconnected (e.g., stored separately from) the encrypted data itself. With that said, a separate database may be more useful in circumstances where, for example, rapid identification of encrypted data that was encrypted using a particular data encryption key is desired. For instance, the database might be used to quickly locate encrypted data that was encrypted using a compromised key.

In step 305, the computing device may receive a key expiration indication. A key expiration indication may be any indication that a key (e.g., a data encryption key, a key encryption key) should no longer be used, such as an indication that a key has been compromised (e.g., that a data encryption key and/or key encryption key has been acquired by a malicious entity), that a data encryption key and/or key encryption key has expired, or the like. For example, the computing device may receive an indication of an expiration of the first key encryption key. That indication might be received internally (e.g., by an internal process maintaining a timer of keys, such as a process that expires key encryption keys after every three years) and/or externally (e.g., by a third-party security system reporting that a key was found on the dark web).

As already indicated above, the key expiration indication may be based on the expiration of a key encryption key and/or data encryption key. Key encryption keys and/or data encryption keys may be periodically rotated for the purposes of security, as doing so means that—even if a key is compromised—the utility of such a compromised key is limited to a particular duration, and the possible theft of older keys (e.g., on legacy systems) does not imperil current data. As such, key encryption keys and/or data encryption keys may be rotated on a periodic basis, such as every three years, every month, or a similar threshold. For example, as part of step 305, the computing device may determine that a duration of use of the first key encryption key satisfies a threshold.

As also already indicated above, the key expiration indication may be based on a compromise of one or more keys. Keys may be compromised in a variety of ways: for example, a key encryption key might be inadvertently acquired by an external party (whether malicious or otherwise), a data encryption key might be stolen by a malicious party, a data encryption key might be insecure due to newly-discovered vulnerabilities in the algorithm used to generate data encryption keys using key encryption keys, or the like. For example, the computing device may determine that the first key encryption key is compromised.

In step 306, the computing device may receive a second key encryption key. The receipt of the second key encryption key may be via one or more external sources (e.g., from an external server and/or second computing device) and/or via one or more internal sources (e.g., via the hardware security module).

In step 307, the computing device may generate a second data encryption key using the second key encryption key. For example, the computing device may generate, using the second key encryption key, a second data encryption key. Various algorithms may be used to generate one or more data encryption keys from a key encryption key. For example, the key encryption key may comprise a seed valuable usable to generate random strings usable as data encryption keys. As another example, the key encryption key may comprise a prefix to be appended to other data to generate a data encryption key. Because security standards and/or encryption standards might change over time, the second key encryption key and the second data encryption keys need not have similarities to previous key encryption keys and/or data encryption keys. For example, while a previous key encryption key might have been a numerical value, subsequent key encryption keys might comprise a lengthy string.

As part of generating the second data encryption key, the computing device may store both the first data encryption key and the second data encryption key in a hardware security module or similar storage medium. In this manner, the hardware security module may store a wide variety of data encryption keys, including older versions of data encryption keys. This may be advantageous because, as indicated above, computing devices may store data encrypted using different data encryption keys, including different versions of data encryption keys, different formats of data encryption keys, and the like. In turn, the hardware security module might store a plurality of keys, whether or not those keys are the latest and/or most secure keys.

As an introduction to step 308 through step 311, the following steps involving decryption of data and re-encryption of that data may be performed once a key has expired, but might be performed at different times, and such a process need not be performed all at once. In general, once a key has been compromised, it may be desirable to convert all data encrypted using that key to a different (e.g., latest version of a) key. With that said, doing so all at once may be computationally complex and time-consuming. Moreover, even if one key is compromised, other keys might be safe, and it may be desirable to only decrypt and re-encrypt certain data. To efficiently decrypt and re-encrypt such data, a variety of approaches may be taken. For example, data might be re-encrypted with a latest version of a key only when the data is decrypted for other reasons (e.g., upon request from a user for the decrypted data). This approach may advantageously preserve uptime and lower the likelihood that computing resources are wasted decrypting and re-encrypted data that will not be used. Moreover, this approach may be more efficient, as the decryption process may be used for both servicing some other process (e.g., a user request) and for re-encryption. As another example, data may be decrypted and re-encrypted based on the importance of the data. In such a circumstance, different data might be tagged based on a priority level, and that priority level may be used to determine which data to decrypt and re-encrypt first. As another example, data may be decrypted and re-encrypted based on the nature of the key expiration indication received in step 305. For instance, in the case of key compromise, substantial computing resources may be devoted to quickly decrypting and re-encrypting data so as to avoid data compromise. With that said, in the same example, in the case of key expiry, a relatively lower quantity of computing resources may be used to slowly decrypt and re-encrypt data at specific times (e.g., outside of ordinary business hours).

In step 308, the computing device may determine whether specific data was encrypted using the first data encryption key. This step may involve confirming, for some set of data (e.g., which may include but need not necessarily be the data described in previous steps), whether the data was encrypted using the key subject to expiration, compromise, or the like. After all, if data was not encrypted using a compromised/expired data encryption key, then there might not be a reason to decrypt and re-encrypt that data using a different key. If the data was encrypted using the first data encryption key, the method 300 proceeds to step 309. Otherwise, the method 300 ends.

In step 309, the computing device may decrypt the data referenced in step 308. In this manner, data encrypted using an expired key (e.g., using an expired data encryption key, using a compromised data encryption key, or the like) may be decrypted back to its original, pre-encryption form (e.g., plaintext). For example, the computing device may, decrypt the encrypted data using the first data encryption key based on a determination that the encrypted data was encrypted using the first data encryption key. In that example, the determination that the encrypted data was encrypted using the first data encryption key may be based on the association between the encrypted data and the version information.

In step 310, the computing device may encrypt (e.g., re-encrypt) the data using the second data encryption key. This may return the data to an encrypted state, albeit encrypted using a different (e.g., more secure and/or not expired) data encryption key. For example, the computing device may encrypt the data using the second data encryption key. The encryption process may be the same or similar as in step 303, albeit with a different encryption key.

In step 311, the computing device may store a new association between the encrypted (e.g., re-encrypted) data and the second data encryption key. For example, the computing device may store, in the database, an association between the encrypted data and second version information corresponding to the second data encryption key.

The process referenced above in step 308, step 309, step 310, and/or step 311 may be repeated for different data. Indeed, the steps described above may be repeated for all sets of data satisfying certain criteria (e.g., all data encrypted using a certain data encryption key, all data associated with a priority level). For example, the computing device may, based on the receiving the indication of the expiration of the first key encryption key, identify second data encrypted using the first data encryption key and, in response to identifying, using a second association between second encrypted data and third version information, that the second encrypted data was encrypted using the first data encryption key, decrypt the second encrypted data using the first data encryption key to generate second data. The computing device may then encrypt the second data using the second data encryption key and store, in the database, an association between the second encrypted data and fourth version information corresponding to the second data encryption key.

The process referenced above in step 308, step 309, step 310, and/or step 311 may be performed in conjunction with servicing requests for data, meaning that data re-encryption using a new key may be performed when the data is already decrypted to provide to a user. This is because, as indicated above, doing so may be more efficient: data is decrypted once but used for different purposes (servicing a request for data and also re-encrypting the data using a different data encryption key). For example, the computing device may receive, from a second computing device, a request for second encrypted data and may, in response to identifying, using a second association between the second encrypted data and third version information, that the second encrypted data was encrypted using the first data encryption key, and after receiving the indication of the expiration of the first key encryption key, decrypt, using the first data encryption key, the second encrypted data to generate second data. The computing device may then send the second data to the second computing device, encrypt the second data using the second data encryption key, and store, in the database, an association between the second encrypted data and fourth version information corresponding to the second data encryption key. With that said, this process might be desirable when the previous data encryption key has expired and has not been compromised-after all, if the data encryption key is compromised, it might be preferable to quickly and efficiently decrypt and re-encrypt all data using that compromised data encryption key so as to avoid any data compromise.

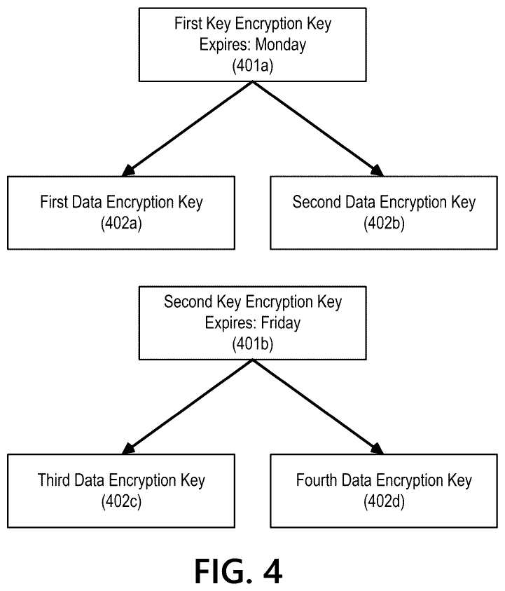

FIG. 4 depicts relationships between key encryption keys and data encryption keys. Specifically, FIG. 4 shows a first key encryption key 401, depicted as expiring on Monday, that was used to generate a first data encryption key 402a and a second data encryption key 402b. FIG. 4 also shows a second key encryption key 401b, expiring Friday, that was used to generate a third data encryption key 402c and a fourth data encryption key 402d. In this manner, FIG. 4 illustrates that different key encryption keys may be used (e.g., with an algorithm) to generate one or more data encryption keys, and those data encryption keys may be different in a wide variety of ways. In such an example, on Tuesday, the first key encryption key 401 might become expired, meaning that the first data encryption key 402a and the second data encryption key 402b might in turn become expired. In such a circumstance, the steps depicted in FIG. 3 might be performed to decrypt and re-encrypt data using the third data encryption key 402c and/or the fourth data encryption key 402d.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device configured to implement changes to encryption keys used to secure data, the computing device comprising:
one or more processors; and
memory storing instructions that, when executed by the one or more processors, cause the computing device to:
receive data to be securely stored in a database;
retrieve, from the computing device, a first data encryption key that was previously generated using a first key encryption key;
encrypt the data using the first data encryption key;
store, in the database, an association between the encrypted data and version information corresponding to the first data encryption key;
based on receiving an indication of an expiration of the first key encryption key:
receive a second key encryption key;
generate, using the second key encryption key, a second data encryption key;
decrypt the encrypted data using the first data encryption key based on a determination that the encrypted data was encrypted using the first data encryption key, wherein the determination that the encrypted data was encrypted using the first data encryption key is based on the association between the encrypted data and the version information;
encrypt the data using the second data encryption key; and
store, in the database, an association between the encrypted data and second version information corresponding to the second data encryption key.

2. The computing device of claim 1, wherein the instructions, when executed by the one or more processors, cause the computing device to:
based on the receiving the indication of the expiration of the first key encryption key:
identify second data encrypted using the first data encryption key;
in response to identifying, using a second association between second encrypted data and third version information, that the second encrypted data was encrypted using the first data encryption key, decrypt the second encrypted data using the first data encryption key to generate second data;
encrypt the second data using the second data encryption key; and
store, in the database, an association between the second encrypted data and fourth version information corresponding to the second data encryption key.

3. The computing device of claim 1, wherein the instructions, when executed by the one or more processors, cause the computing device to receive the second key encryption key further based on determining that the first key encryption key is compromised.

4. The computing device of claim 1, wherein the instructions, when executed by the one or more processors, cause the computing device to:
receive, from a second computing device, a request for second encrypted data;
in response to identifying, using a second association between the second encrypted data and third version information, that the second encrypted data was encrypted using the first data encryption key, and after receiving the indication of the expiration of the first key encryption key:
decrypt, using the first data encryption key, the second encrypted data to generate second data;
send the second data to the second computing device;
encrypt the second data using the second data encryption key; and
store, in the database, an association between the second encrypted data and fourth version information corresponding to the second data encryption key.

5. The computing device of claim 1, wherein the instructions, when executed by the one or more processors, cause the computing device to receive the indication of the expiration of the first key encryption key by causing the computing device to:
determine that a duration of use of the first key encryption key satisfies a threshold.

6. The computing device of claim 1, wherein the instructions, when executed by the one or more processors, cause the computing device to:
store both the first data encryption key and the second data encryption key in ta Hardware Security Module (HSM).

7. The computing device of claim 1, wherein the association between the encrypted data and the version information is stored in a header of the encrypted data.

8. A method for implementing changes to encryption keys used to secure data, the method comprising:
receive data to be securely stored in a database;
retrieving a first data encryption key that was previously generated using a first key encryption key;
encrypting the data using the first data encryption key;
storing, in the database, an association between the encrypted data and version information corresponding to the first data encryption key;
based on receiving an indication of an expiration of the first key encryption key:
receiving a second key encryption key;
generating, using the second key encryption key, a second data encryption key;
decrypting the encrypted data using the first data encryption key based on a determination that the encrypted data was encrypted using the first data encryption key, wherein the determination that the encrypted data was encrypted using the first data encryption key is based on the association between the encrypted data and the version information;
encrypting the data using the second data encryption key; and
storing, in the database, an association between the encrypted data and second version information corresponding to the second data encryption key.

9. The method of claim 8, further comprising:
based on the receiving the indication of the expiration of the first key encryption key:
identifying second data encrypted using the first data encryption key;
in response to identifying, using a second association between second encrypted data and third version information, that the second encrypted data was encrypted using the first data encryption key, decrypting the second encrypted data using the first data encryption key to generate second data;
encrypting the second data using the second data encryption key; and
storing, in the database, an association between the second encrypted data and fourth version information corresponding to the second data encryption key.

10. The method of claim 8, wherein the receiving the second key encryption key further based on determining that the first key encryption key is compromised.

11. The method of claim 8, further comprising:
receiving, from a second computing device, a request for second encrypted data;
in response to identifying, using a second association between the second encrypted data and third version information, that the second encrypted data was encrypted using the first data encryption key, and after receiving the indication of the expiration of the first key encryption key:
decrypting, using the first data encryption key, the second encrypted data to generate second data;
sending the second data to the second computing device;
encrypting the second data using the second data encryption key; and
storing, in the database, an association between the second encrypted data and fourth version information corresponding to the second data encryption key.

12. The method of claim 8, wherein receiving the indication of the expiration of the first key encryption key further comprises:
determining that a duration of use of the first key encryption key satisfies a threshold.

13. The method of claim 8, further comprising:
storing both the first data encryption key and the second data encryption key in a Hardware Security Module (HSM).

14. The method of claim 8, wherein the association between the encrypted data and the version information is stored in a header of the encrypted data.

15. One or more non-transitory computer-readable media storing instructions that, when executed by one or more processors of a computing device, cause the computing device to implement changes to encryption keys used to secure data by causing the computing device to:
receive data to be securely stored in a database;
retrieve, from the computing device, a first data encryption key that was previously generated using a first key encryption key;
encrypt the data using the first data encryption key;
store, in the database, an association between the encrypted data and version information corresponding to the first data encryption key;
based on receiving an indication of an expiration of the first key encryption key:
receive a second key encryption key;
generate, using the second key encryption key, a second data encryption key;
decrypt the encrypted data using the first data encryption key based on a determination that the encrypted data was encrypted using the first data encryption key, wherein the determination that the encrypted data was encrypted using the first data encryption key is based on the association between the encrypted data and the version information;
encrypt the data using the second data encryption key; and
store, in the database, an association between the encrypted data and second version information corresponding to the second data encryption key.

16. The one or more non-transitory computer-readable media of claim 15, wherein the instructions, when executed by the one or more processors, cause the computing device to:
based on the receiving the indication of the expiration of the first key encryption key:
identify second data encrypted using the first data encryption key;
in response to identifying, using a second association between second encrypted data and third version information, that the second encrypted data was encrypted using the first data encryption key, decrypt the second encrypted data using the first data encryption key to generate second data;
encrypt the second data using the second data encryption key; and
store, in the database, an association between the second encrypted data and fourth version information corresponding to the second data encryption key.

17. The one or more non-transitory computer-readable media of claim 15, wherein the instructions, when executed by the one or more processors, cause the computing device to receive the second key encryption key further based on determining that the first key encryption key is compromised.

18. The one or more non-transitory computer-readable media of claim 15, wherein the instructions, when executed by the one or more processors, cause the computing device to:
receive, from a second computing device, a request for second encrypted data;
in response to identifying, using a second association between the second encrypted data and third version information, that the second encrypted data was encrypted using the first data encryption key, and after receiving the indication of the expiration of the first key encryption key:
decrypt, using the first data encryption key, the second encrypted data to generate second data;
send the second data to the second computing device;
encrypt the second data using the second data encryption key; and
store, in the database, an association between the second encrypted data and fourth version information corresponding to the second data encryption key.

19. The one or more non-transitory computer-readable media of claim 15, wherein the instructions, when executed by the one or more processors, cause the computing device to receive the indication of the expiration of the first key encryption key by causing the computing device to:
determine that a duration of use of the first key encryption key satisfies a threshold.

20. The one or more non-transitory computer-readable media of claim 15, wherein the instructions, when executed by the one or more processors, cause the computing device to:
store both the first data encryption key and the second data encryption key in a Hardware Security Module (HSM).
